(19) United States
(12) Patent Application Publication
(10) Pub. No.: US 2014/0167531 A1
(43) Pub. Date: Jun. 19, 2014

(54) ROTOR AND ELECTRIC MOTOR

(71) Applicant: Hanning Elektro-Werke GmbH & Co. KG, Oerlinghausen (DE)

(72) Inventor: Werner Hangmann, Schloss Holte-Stukenbrock (DE)

(73) Assignee: Hanning Elektro-Werke GmbH & Co. KG, Oerlinghausen (DE)

(21) Appl. No.: 14/104,179

(22) Filed: Dec. 12, 2013

(30) Foreign Application Priority Data
Dec. 13, 2012 (DE) 10 2012 112 228.8

(51) Int. Cl. H02K 5/12

(52) U.S. Cl. CPC H02K 5/12
USPC 310/43

(57) ABSTRACT

A rotor for an electric motor, in particular for synchronous motors of wet-running pumps, with a rotor core on the periphery of which a number of magnets are arranged, the rotor core and the magnets being surrounded by a plastics material casing. The magnets each have a receiving groove on a peripheral face remote from the rotor core.

The invention relates to a rotor for an electric motor, in particular for synchronous motors of wet-running pumps, comprising a rotor core on the periphery of which a number of magnets are arranged, the rotor core and the magnets being surrounded by a plastics material casing.

EP 1 841 041 A1 discloses a rotor for an electric motor, which comprises a rotor core and a number of magnets arranged peripherally on the rotor core. On the one hand, the rotor core comprises a laminated core. On the other hand, the rotor core comprises a peripheral plastics material extrusion coating, in which magnet pockets for receiving the magnets are formed. After the magnets are inserted into the magnet pockets, the rotor core which has been expanded in this manner is encased peripherally with plastics material, in such a way that the rotor is protected against the penetration of corrosion-inducing moisture. However, a drawback of this motor is that the plastics material casing is of a relatively large radial extent, in such a way that there is an enlarged “magnetic gap” from the stator, and this limits the performance of the electric motor.

An object of the present invention is therefore to develop a rotor or an electric motor in such a way that corrosion protection of the rotor is ensured in a simple manner whilst the performance properties thereof are improved.

To achieve the object, the invention in connection with the preamble of claim 1 is characterized in that the magnets each comprise a receiving groove on a peripheral face remote from the rotor core.

The particular advantage of the invention is that a plastics material casing which sheathes the rotor core and the magnets may be of a relatively low wall thickness, in such a way that the radial distance (magnetic gap) between the rotor and a stator of the electric motors can be selected to be small with low losses. A radial minimum thickness of the plastics material casing, which has to be present to compensate centrifugal forces acting on the magnets during operation of the electric motor, can be selected to be smaller, since forming a receiving groove on an outer peripheral face of the magnets leads to a partial increase in wall thickness of the plastics material casing. This partial increase in wall thickness of the plastics material casing leads to local reinforcement of the plastics material casing. This in effect acts as a “safety belt” for the magnets, which makes an increased, radially inwardly directed holding force on the magnets possible. A predetermined motor performance can thus be brought about using less metal material for the rotor or stator, and this reduces the costs or the use of material. In a simple manner in terms of manufacture, the partial wall thickness increase can be provided in a single method step together with the plastics material extrusion coating or plastics material casing of the rotor core. When the extrusion nozzles of the extrusion coating tool are directed towards the receiving grooves of the magnets, the process safety of the extrusion coating process can additionally be increased. The increased free space inside the extrusion coating tool in the region of the receiving grooves can be used as a flow duct for the mass of plastics material, and thus simplifies the filling of the free mould space inside the tool. Because of the relatively low flow resistance along the receiving groove, the primary current of the mass of plastics material will move along this receiving groove, from where it will fill the entire free space of the moulding tool.

In accordance with a preferred embodiment of the invention, the receiving groove extends in a straight line between a first end face and a second end face of the magnets. Advantageously, the axial receiving grooves which are formed in this manner bring about a reduction in the torque undulation. Advantageously, the electric motor can be operated with less vibration as a result.

In accordance with a development of the invention, the receiving grove extends in a region of the magnets in which a centrifugal force acting on the respective magnet during motor operation is greatest. The receiving force may for example be arranged in the region of a longitudinal central plane of the magnet when the contour, extending in the peripheral direction, of the outer peripheral face of the magnet extends in an arc or circle shape.

In accordance with a development of the invention, the magnets are in the form of ferrite magnets, which react less with the conveying medium of a pump, into which the electric motor provided with the magnets is integrated. The risk of corrosion can be further reduced as a result.

In accordance with a development of the invention, the magnets are directly connected to the rotor core in a material fit, preferably by gluing. Advantageously, in this embodiment merely a single plastics material extrusion coating process is required.

In accordance with an alternative embodiment of the invention, the magnets are each inserted into magnet pockets which are applied by extrusion onto the rotor core or by extrusion coating thereof. The magnet pockets advantageously serve as a positioning aid for the magnets during the production process.

In accordance with a development of the invention, the rotor core is rotationally engaged with a motor shaft, a sealing ring, by means of which the rotor is protected from the entry of liquid in a region close to the axis, being arranged in an end region of the rotor core.

To achieve the object, the invention comprises an electric motor comprising a conventional stator and comprising a rotor containing magnets, which are attached to a rotor core and which comprise externally formed receiving grooves, in such a way that the effectiveness of the electric motor can be increased with the same use of material.

Embodiments of the invention are described in greater detail in the following by way of the drawings, in which:

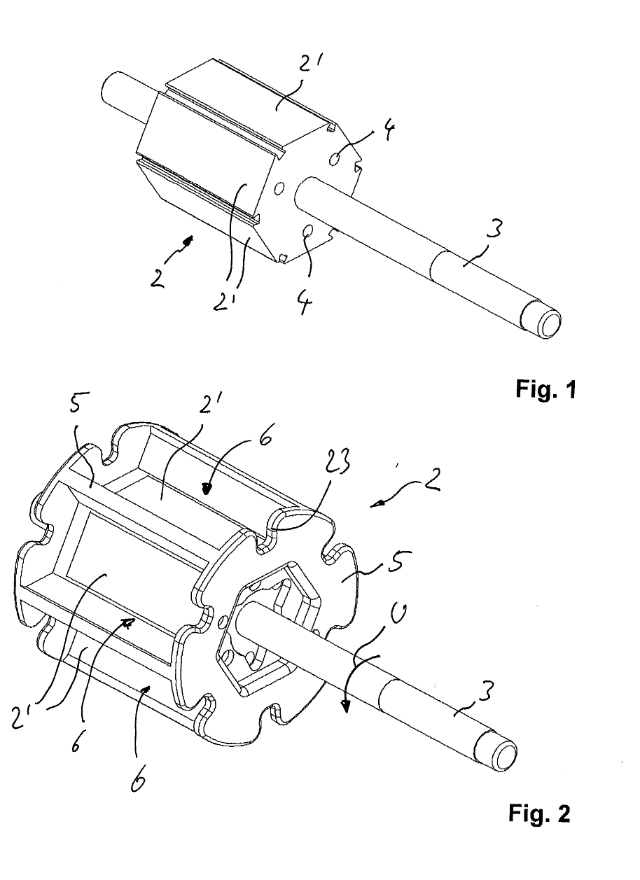

FIG. 1 is a perspective drawing of a rotor core rotationally engaged with a shaft,

FIG. 2 is a perspective drawing of a first plastics material extrusion coating of the rotor core for forming magnet pockets in accordance with a first embodiment of a rotor in a first extrusion coating step,

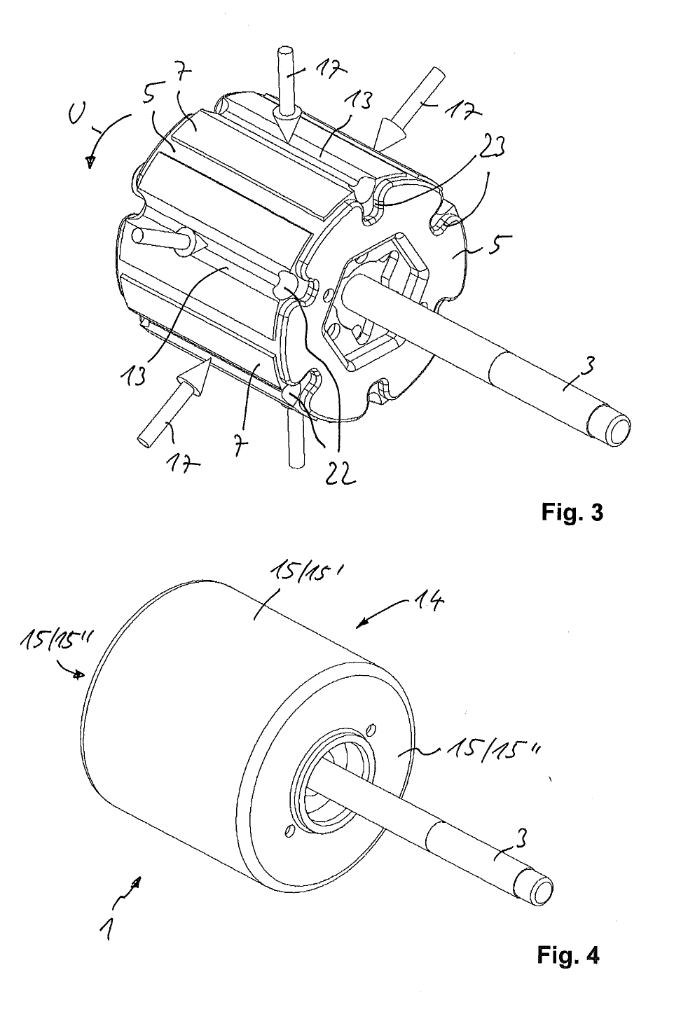

FIG. 3 is a perspective drawing of the first embodiment of the invention in a further method step in which the magnets are inserted into the magnet pockets according to FIG. 2, a subsequent plastics material casing according to FIG. 4 taking place by way of schematically shown radially acting injection nozzles,

FIG. 4 is a perspective drawing of the invention in accordance with the first embodiment in a further, second extrusion step, in which a plastics material casing has been provided by extrusion-coating the rotor core and the magnets,

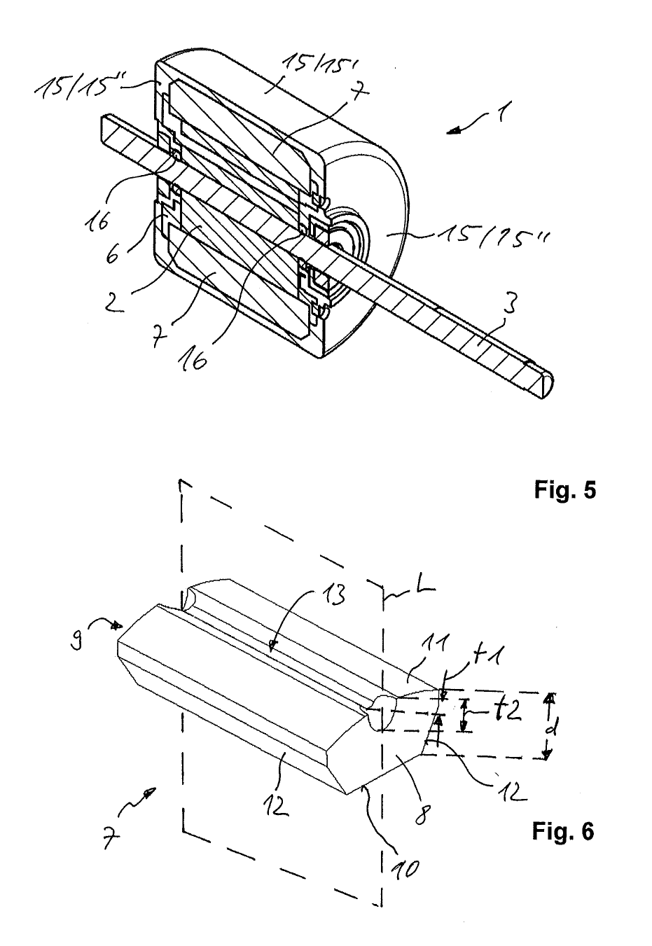

FIG. 5 is a longitudinal section through the rotor in accordance with the first embodiment comprising sealing rings arranged in an end region of the rotor,

FIG. 6 is a perspective drawing of the magnet,

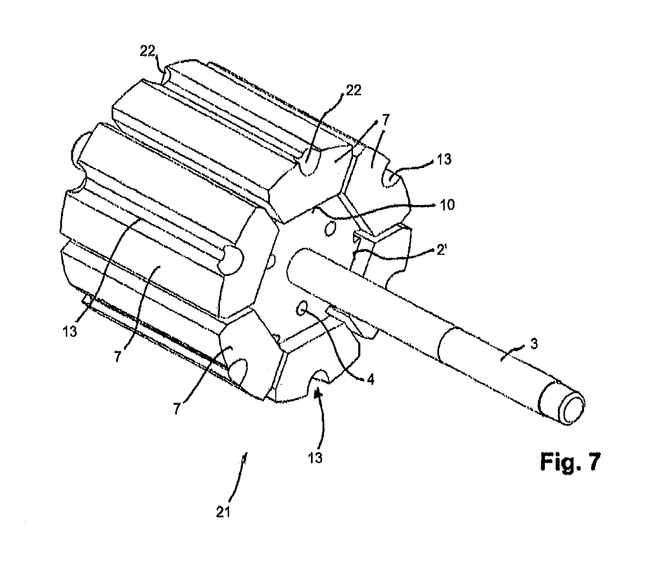

FIG. 7 is a perspective drawing of the rotor core, onto the periphery of which the magnets are directly glued in accordance with a second embodiment of the invention.

A rotor according to the invention, together with a stator (not shown), forms an electric motor which can be used for example as a synchronous motor for wet-running pumps in household appliances.

A rotor 1 in accordance with a first embodiment in accordance with FIGS. 1 to 6 comprises a rotor core 2, which is composed of a plurality of laminated cores and which can be pressed or shrink-fitted onto a shaft 3. The rotor core 2 is thus rotationally engaged with the motor shaft 3. The laminated core consists of a plurality of rotor sheets, which are arranged mutually coaxially and which each have centring holes 4 for centring the rotor core 2 with respect to the shaft 3. In the present embodiment, the rotor core 2 comprises six peripheral faces 2′ which are arranged distributed in the peripheral direction U.

In accordance with the first embodiment of the invention, the rotor core 1 is inserted together with the shaft 3 into the mould space of an extrusion coating tool, the mould space being configured in such a way that after the mould space is filled with a thermoplastic plastics material mass and said mass has cooled a first plastics material extrusion 5 in accordance with FIG. 2 takes place. This first plastics material extrusion 5 is formed coaxial with the shaft 3 and comprises six magnet pockets 6 which are arranged distributed in the peripheral direction U. Magnets 7 are respectively inserted into the magnet pockets 6 and connected to the frame-shaped first plastics material extrusion 5, in particular the respective magnet pockets 6, in a positive and/or non-positive fit via corresponding fastening means. For example, the magnet pockets 6 may comprise respective latching means, in such a way that the magnets 7 are each in effect positively secured from falling out. The magnets 7 are preferably in the form of ferrite magnets. The magnet pockets 6 and the magnets 7 are arranged concentric with the rotors 2 or with the shaft 3.

The magnets 7 are each formed elongate and comprise, between a first end face 8 and a second end face 9, a planar inner peripheral face 10 and an outer peripheral face 11 which extends substantially in an arc shape. In the longitudinal direction, the inner peripheral face 10 and the outer peripheral face 11 are interconnected by means of opposing narrow faces 12 which are likewise elongate. The narrow faces 12 are at an obtuse angle to the planar inner peripheral face 10, in such a way that the magnets 7, in cross-section, have a contour which extends tapering towards the shaft. This makes it easier to insert the magnets 7 into the magnet pockets 6.

On the outer peripheral face 11, the magnets 7 each comprise a receiving groove 13, which extends in a straight line in the longitudinal direction of the magnet 7 or in the axial direction of the rotor 1, preferably from the first end face 8 to the second end face 9. The receiving groove 13 serves to receive a plastics material of a plastics material casing 15, which surrounds the rotor 1 or the magnets 7 completely in the peripheral direction. The plastics material casing 15 is of a constant radial wall thickness, apart from in regions in which the receiving groove 13 of the magnets 7 extends in each case. The wall thickness of the plastics material casing 15 in the region of the receiving grooves 13 is greater than in the further regions of the plastics material casing 15. The receiving groove 13 extends in the region of a longitudinal central plane L of the magnet 7. The receiving groove 13 is of a groove depth t1 which corresponds to approximately a third of the thickness d of the magnet 7. The groove depth t1 of the receiving groove 13 is thus smaller than half of the thickness d of the magnet 7.

The longitudinal central plane L forms a plane of symmetry of the magnet 7. When the magnet 7 is mounted, the longitudinal central plane L intersects an axis of the shaft 3. The magnets 7 are arranged concentric with the rotor core 2.

After the magnets 7 have been inserted into the magnet pockets 6, in a further method step the rotor core 2 which has been expanded in this manner is laid, together with the shaft 3, in the mould space of an extrusion coating tool, in such a way that a second plastics material extrusion 14 in accordance with FIG. 4 can take place. The second plastics material extrusion 14 forms the plastics material casing 15, which comprises an axial case portion 15′ for peripherally covering the magnets 7 and the rotor core 2, on the one hand, and which comprises a radial case potion 15″ for covering the end faces of the magnets 7 or the rotor core 2, on the other hand. The rotor core is now, together with the magnets 7, virtually surrounded by the plastics material casing 15. For sealing close to the axis, a sealing ring 16 (O-ring) is in each case fastened to an annular groove of the shaft 3 in the end region of the rotor core 2; see FIG. 5. The annular groove is of a width which is less than a line thickness of the sealing ring 16, resulting in radial compression.

The receiving groove 13 of the magnets 7 in each case comprises a bevel 22, by means of which the plastics material mass entering the mould space of the extrusion coating tool can be distributed more easily, on the end face. Further, a notch effect, of the edges of the magnets 7 arranged on the end faces 8, 9, on the second plastics material extrusion 14 is prevented as a result of centrifugal forces during motor operation. A depth t2 of the bevel 22 is shown in FIG. 6 and is greater than the groove depth t1 of the receiving groove 13.

As can be seen in particular from FIGS. 2 and 3, the mould space of the extrusion coating tool is formed in such a way that the plastics material extrusion 5 comprises a radial recess 23 in the extension of the receiving groove 13. The plastics material extrusion 5 thus comprises annular portions, which follow the contour of the magnets 7 at the periphery, at the end faces of the rotor core 2.

In accordance with a second embodiment of the invention, a rotor 21 is provided which differs from the rotor 1 in accordance with the first embodiment in that the planar inner peripheral faces 10 of the magnets 7 are fastened directly to the peripheral faces 2′ of the rotor core 2 in a material fit. For example, the magnets 7 can be fastened to the rotor core 2 by gluing.

Like components or component functions of the embodiments are provided with like reference numerals.

Thus, merely a single plastics material extrusion 14 takes place to produce the rotor 21, in such a way that the rotor 21 is of the same external shape as the rotor 1.

FIG. 3 schematically shows, by means of the arrows 17, that the plastics material mass is introduced into the mould space in the radial direction in the region of the receiving grooves, in such a way that the plastics material mass flow can be deflected and guided in the longitudinal direction by means of the receiving groove 13 until the free space of the moulding tool is completely filled up.

It will be appreciated that the magnets 7 for the two rotors 1 and 2 are of the same shaping.

1. A rotor (1) for an electric motor, comprising a rotor core (2) on the periphery of which a number of magnets (7) are arranged, the rotor core (2) and the magnets (7) being surrounded by a plastics material casing (15), wherein the magnets (7) each comprise a receiving groove (13) on a peripheral face (11) remote from the rotor core (2).

2. The rotor according to claim 1, wherein the receiving groove (13) extends in a straight line from a first end face (8) to a second end face (9) of the magnet (7).

3. The rotor according to claim 1, wherein the receiving groove (13) is arranged in a region of the magnet (7) in which a centrifugal force acting on the magnet (7) during motor operation is greatest.

4. The rotor according to claim 1, wherein the receiving groove (13) is arranged extending in the region of a longitudinal central plane (L) of the magnet (7).

5. The rotor according to claim 1, wherein the magnet (7) is a ferrite magnet.

6. The rotor according to claim 1, wherein the plastics material casing (15) comprises an axial case portion (15′) for peripherally covering the magnets (7) and the rotor core (2), on the one hand, and/or a radial case potion (15″) for covering the end faces of the magnets (7) or the rotor core (2), on the other hand.

7. The rotor according to claim 1, wherein the magnets (7) are directly connected to the rotor core (2) in a material fit.

8. The rotor according to claim 1, wherein the magnets (7) are respectively mounted in magnet pockets (6) applied to the rotor core (2) by extrusion.

9. The rotor according to claim 8, wherein the magnets (7) are mounted in the respective magnet pockets (6) by way of positively and/or non-positively acting fastening means.

10. The rotor according to claim 1, wherein the plastics material casing (15) and/or the magnet pockets (6) consist of a thermoplastic plastics material.

11. The rotor according to claim 1, wherein the rotor core (2) is rotationally engaged with a shaft (3) and a sealing ring (16) is fastened to the shaft (3) in an end region of the rotor core (2).

12. An electric motor comprising a stator and comprising a rotor according to claim 1.

13. The rotor according to claim 1, wherein the electric motor is a synchronous motor of a wet-running pump.
